(19) United States
(12) Patent Application Publication
(10) Pub. No.: US 2022/0292868 A1
(43) Pub. Date: Sep. 15, 2022

(54) FINGERPRINT IMAGE SENSOR AND ELECTRONIC DEVICE

(71) Applicant: Egis Technology Inc., Hsinchu City (TW)

(72) Inventors: Chih-Chung Tu, Hsinchu City (TW); Po-Jui Liao, Hsinchu City (TW)

(73) Assignee: Egis Technology Inc., Hsinchu City (TW)

(21) Appl. No.: 17/636,358

(22) PCT Filed: Feb. 25, 2020
(86) PCT No.: PCT/CN2020/076523

§ 371 Date: Feb. 18, 2022

Related U.S. Application Data
(60) Provisional application No. 62/895,503, filed on Sep. 4, 2019.

(51) Int. Cl. G06V 40/13

(52) U.S. Cl. CPC G06V 40/1318

(57) ABSTRACT

The present invention provides a fingerprint image sensor and an electronic device. The fingerprint image sensor is suitable for being configured below a display panel and comprises a substrate and a plurality of photosensitive pixels. The plurality of photosensitive pixels is arranged on the substrate to form a photosensitive array having M rows and N columns. The photosensitive pixels located on each row of the photosensitive array are arranged along the row direction, and the photosensitive pixels located on each column of the photosensitive array are arranged along the column direction. Each photosensitive pixel comprises a photoinduction region, and the photoinduction region comprises a first region side edge and a second region side edge. An acute angle is formed between the first region side edge and the second region side edge, and the acute angle is larger than 0 degree and smaller than 90 degrees.

### TECHNICAL FIELD

The invention relates to a fingerprint sensing technology, and in particular, to a fingerprint image sensor and an electronic device.

### DESCRIPTION OF RELATED ART

As technology advances, the technology of fingerprint recognition has gradually been widely applied to various electronic devices or products. There are various types of the fingerprint recognition technology such as capacitive, optical, or ultrasonic fingerprint recognition technology, and they are gradually developed and improved. With a trend that a portable electronic device (e.g. a smart phone or a table computer) is developed to be equipped with a large screen or a full screen, a conventional capacitive fingerprint sensing module located beside the screen cannot be disposed at the front side of the electronic device. In this case, for a more convenient user experience, a solution of under-screen fingerprint recognition where an optical fingerprint image sensor is configured below the screen has been gradually emphasized.

However, a conventional display panel includes multiple display pixel structures arranged according to a specific space frequency, and photosensitive pixels in the fingerprint image sensor are also arranged according to a specific space frequency. As a result, in a case where the fingerprint image sensor is assembled under the display panel, an interference Moire pattern may be generated on a fingerprint image sensed by the fingerprint image sensor, leading to distortion of the fingerprint image and thus affecting the accuracy of the fingerprint recognition. Specifically, FIG. 1 is a schematic diagram of a layout of a conventional fingerprint image sensor. A fingerprint image sensor 10 may include multiple photosensitive pixels (e.g. photosensitive pixels PA) arranged in an array, and each of the photosensitive pixels has a photoinduction region (e.g. a photoinduction region Z1) in a shape of a rectangle. Accordingly, if the space frequency of the photosensitive pixels in the fingerprint image sensor 10 is similar to the space frequency of the display pixel structures in the display panel, there may be interference stripes (i.e. the Moire pattern) on a fingerprint image generated by the fingerprint image sensor 10.

In an existing solution, in a process of assembling the fingerprint image sensor under the display panel, the entire fingerprint image sensor is rotated to reduce the negative effect of the Morie pattern. Referring to FIG. 2, FIG. 2 is a schematic diagram of a rotated fingerprint image sensor. The fingerprint image sensor 10 is rotated a specific angle θ and assembled under a display panel 11. However, since the conventional fingerprint image sensor is generally manufactured in a shape of a rectangle with a specific size, rotating the entire fingerprint image sensor cannot be realized in the application of the under-screen fingerprint recognition of large-area fingerprint sensing.

### SUMMARY

Accordingly, the invention provides a fingerprint image sensor and an electronic device capable of reducing a negative effect of a Moire pattern and enhancing fingerprint image quality.

The embodiment of the invention provides a fingerprint image sensor including a substrate and multiple photosensitive pixels. The multiple photosensitive pixels are arranged to be a photosensitive array having M rows and N columns on the substrate. M and N are positive integers. The photosensitive pixels on each row of the photosensitive array are arranged along a row direction, and the photosensitive pixels on each column of the photosensitive array are arranged along a column direction. Each photosensitive pixel includes a photoinduction region, and the photoinduction region has a first region side edge and a second region side edge. There is an acute angle between the first region side edge and the second region side edge, and the acute angle is greater than 0 and less than 90 degrees.

The embodiment of the invention provides an electronic device including a display panel and a fingerprint image sensor. The fingerprint image sensor is configured below the display panel and includes a substrate and multiple photosensitive pixels. The multiple photosensitive pixels are arranged to be a photosensitive array having M rows and N columns on the substrate. M and N are positive integers. The photosensitive pixels on each row of the photosensitive array are arranged along a row direction, and the photosensitive pixels on each column of the photosensitive array are arranged along a column direction. Each photosensitive pixel includes a photoinduction region, and the photoinduction region has a first region side edge and a second region side edge. There is an acute angle between the first region side edge and the second region side edge, and the acute angle is greater than 0 and less than 90 degrees.

Based on the above, in the embodiment of the invention, there is the acute angle between the first region side edge and the second region side edge of the photoinduction region of the photosensitive pixel so that the photoinduction region of each of the photosensitive pixels is not a conventional rectangle. As a result, in a case where the fingerprint image sensor is configured below the display panel, a correlation between a space frequency of a pixel structure on the display panel and a space frequency of the photosensitive pixel may be changed to greatly reduce the negative effect caused by the Moire pattern on the fingerprint image.

In order to make the aforementioned features and advantages of the invention comprehensible, embodiments accompanied with drawings are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a layout of a conventional fingerprint image sensor.

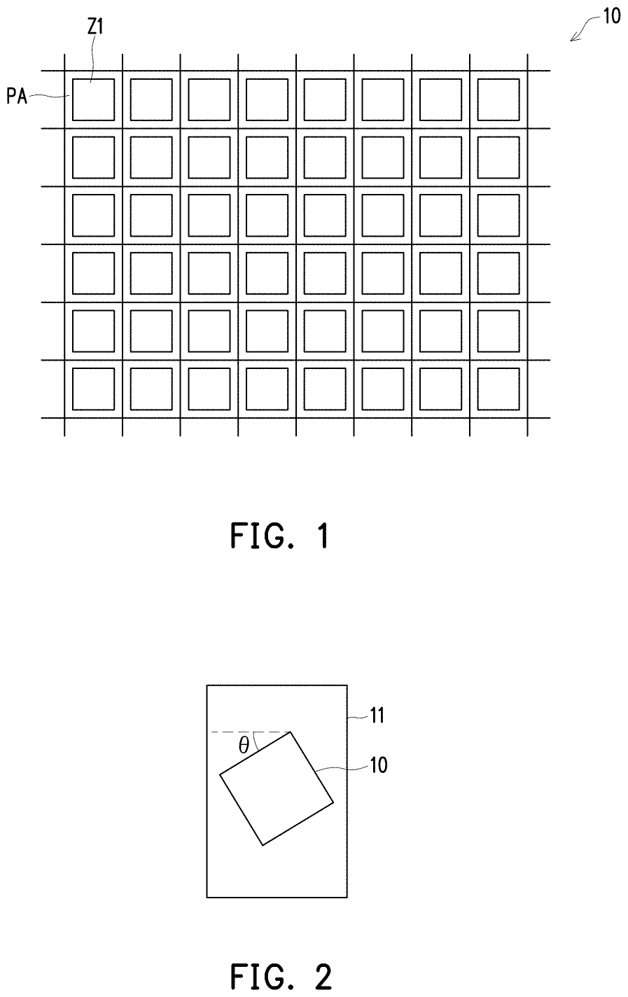

FIG. 2 is a schematic diagram of a rotated fingerprint image sensor.

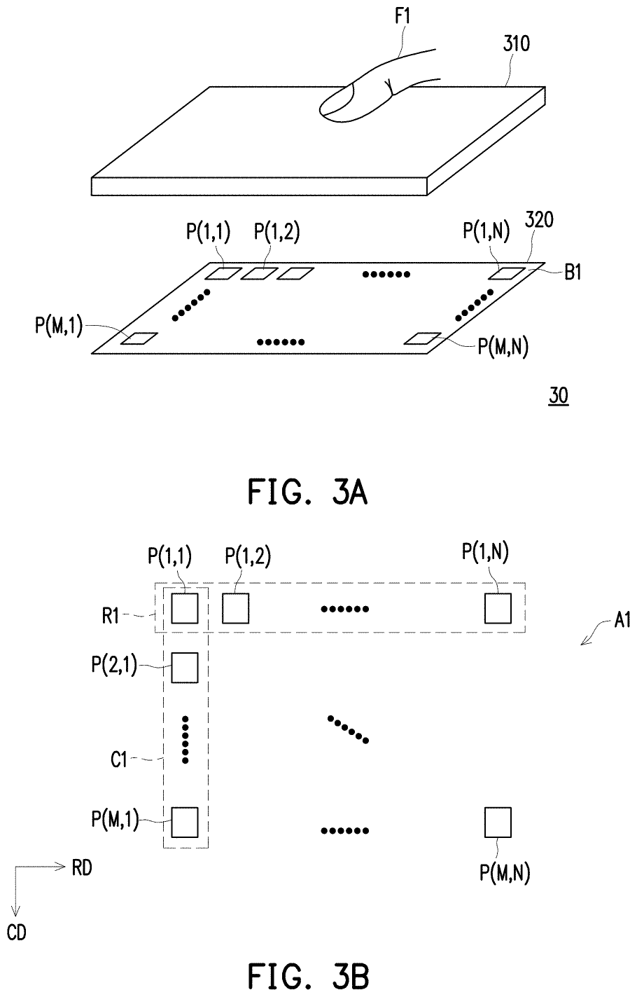

FIG. 3A is a schematic diagram of an electronic device according to an embodiment of the invention.

FIG. 3B is a schematic diagram of a photosensitive array according to an embodiment of the invention.

FIG. 4A to FIG. 4C are schematic diagrams of photosensitive pixels according to an embodiment of the invention.

FIG. 5 is a schematic diagram of a layout of a fingerprint image sensor according to an embodiment of the invention.

FIG. 6 is a schematic diagram of a layout of a fingerprint image sensor according to an embodiment of the invention.

FIG. 7 is a schematic diagram of a layout of a fingerprint image sensor according to an embodiment of the invention.

FIG. 8A is a simulation diagram of a Moire pattern of a conventional rotated image sensor.

FIG. 8B to FIG. 8D are simulation diagrams of a Moire pattern of adjustment of a photoinduction region according to an embodiment of the invention.

### REFERENCE SIGNS LIST

10: fingerprint image sensor;
Z1: photoinduction region;
PA: photosensitive pixel;
11: display panel;
30: electronic device;
310: display panel;
320: fingerprint image sensor;
F1: finger;
B1: substrate;
P(1,1)˜P(M,N): photosensitive pixel;
A1: photosensitive array;
C1: first column;
R1: first row;
RD: row direction;
CD: column direction;
P1: first type photosensitive pixel;
P2: second type photosensitive pixel;
P3: third type photosensitive pixel;
TD1: first inclination direction;
TD2: second inclination direction;
DL: scan line;
E1: first region side edge;
E2: second region side edge;
E3: third region side edge;
E4: fourth region side edge;
E5: fifth region side edge;
E6: sixth region side edge;
RL: data reading line;
Ri: ith row;
R(i+1): (i+1)th row;
R(i+2): (i+2)th row;
R(i+3): (i+3)th row;
81˜82: photosensitive array;
91: display panel;
Img1˜Img4: sensing image.

### DESCRIPTION OF THE EMBODIMENTS

Reference will now be made in detail to the present exemplary embodiments of the invention, examples of which are illustrated in the accompanying drawings. Wherever possible, the same reference numerals are used in the drawings and the description to refer to the same or like parts.

It should be understood that when an element such as a layer, a film, an area, or a substrate is indicated to be “on” another element or “connected to” another element, the element may be directly on the other element or connected to the other element, or there may be an intermediate element. In contrast, when an element is indicated to be “directly on another element” or “directly connected to” another element, there is no intermediate element. As used herein, “connection” may indicate physical and/or electrical connection. Furthermore, for “electrical connection” or “coupling”, there may be another element between two elements.

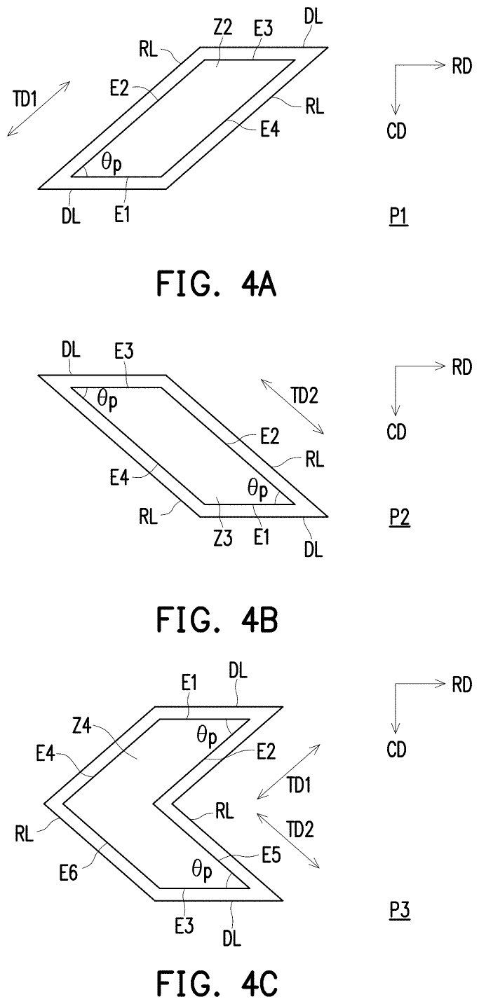

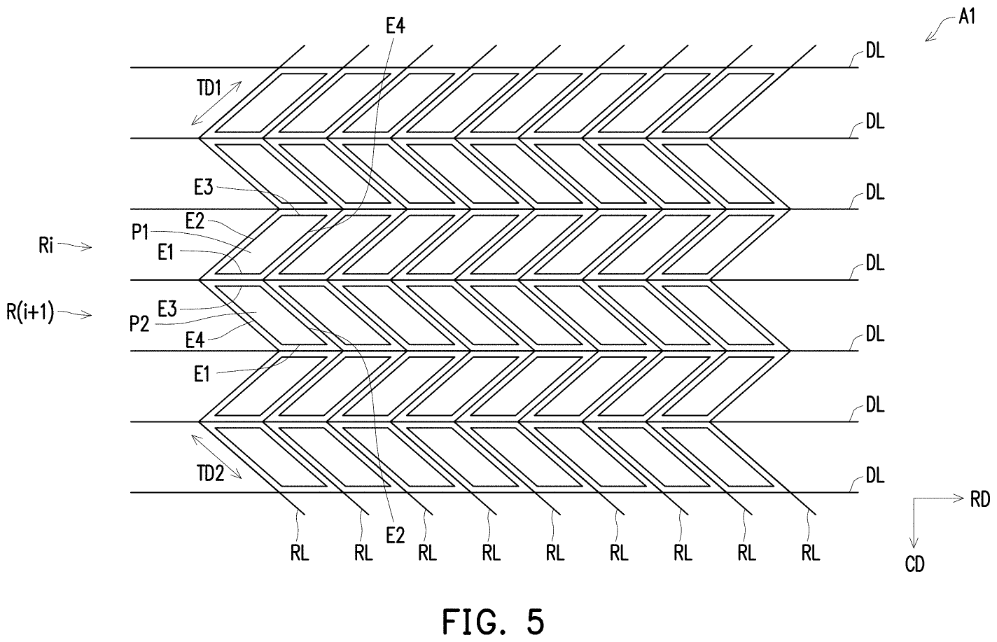

FIG. 3A is a schematic diagram of an electronic device according to an embodiment of the invention. Referring to FIG. 3A, an electronic device 30 may sense fingerprint information of a finger F1 and may be realized as a smart phone, a panel, a game console, or other electronic products having a function of under-screen fingerprint recognition, and the invention is not limited thereto.

The electronic device 30 includes a display panel 310 and a fingerprint image sensor 320. In an embodiment, the display panel 310 may provide an illumination beam to the finger F1 to reflect a sensing beam. In an embodiment, the display panel 310 is, for example, a transparent display panel. However, in other embodiments, the display panel 310 may also be a display panel having a light-passing opening at a region above the fingerprint image sensor 320. The display panel 310 is, for example, a display panel having an organic light-emitting device (OLED). However, in other embodiments, the display panel 310 may also be a liquid crystal display panel or other suitable display panels.

The fingerprint image sensor 320 is configured below the display panel 310 and capable of sensing the sensing beam reflected by the finger F1. The sensing beam reflected by the finger F1 includes the fingerprint information. Specifically, a user may put the finger F1 above the display panel 310, and the sensing beam reflected by the finger F1 passes through the display panel 310 to be transmitted to the fingerprint image sensor 320. The fingerprint image sensor 320 includes a substrate B1 and multiple photosensitive pixels P(1,1), . . . , P(M,1), . . . , P(1,N), . . . , P(M,N). M and N may be any positive integers determined according to design requirements. FIG. 3B is a schematic diagram of a photosensitive array according to an embodiment of the invention. Referring to FIG. 3B, the photosensitive pixels P(1,1) to P(M,N) are arranged to be a photosensitive array A1 having M rows and N columns on the substrate B1. M and N are positive integers. The photosensitive pixels on each row of the photosensitive array A1 are arranged along a row direction RD, and the photosensitive pixels on each column of the photosensitive array A1 are arranged along a column direction CD. For example, the photosensitive pixels P(1,1) to P(1,N) on a first row R1 of the photosensitive array A1 are arranged along the row direction RD, and the photosensitive pixels P(1,1) to P(M,1) on a first column C1 of the photosensitive array A1 are arranged along the column direction CD. In addition, the fingerprint image sensor 320 may further include other necessary electronic circuits, such as a timing control circuit, a reading circuit, a driving circuit, and the like, and the invention is not limited thereto.

Each of the photosensitive pixels P(1,1) to P(M,N) includes a photoinduction region configured to receive the sensing beam reflected by the finger F1. In some embodiments, each of the photosensitive pixels P(1,1) to P(M,N) may include a photo-diode having the photoinduction region. When receiving the sensing beam, the photo-diode may affect the sensing beam and cause image charges to accumulate. The photo-diode is, for example, a PN photo-diode, a PNP photo-diode, an NP photo-diode, an NPN photo-diode, and the like. Note that the photo-diode is only one type of implementation, and other suitable photosensitive component may also be adopted as long as the component may accumulate the image charges when receiving the sensing beam. In addition, each of the photosensitive pixels P(1,1) to P(M,N) may further include other necessary electronic component, such as a transistor and a capacitor for various purposes, and the invention is not limited thereto.

It is worth noting that, in the embodiment of the invention, the photoinduction region of each of the photosensitive pixels P(1,1) to P(M,N) has a first region side edge and a second region side edge. There is an acute angle between the first region side edge and the second region side edge, and the acute angle is greater than 0 and less than 90 degrees. In other words, the photoinduction region of each of the photosensitive pixels P(1,1) to P(M,N) is not in a shape of a rectangle. In an embodiment, when the first region side edge of the photoinduction region extends along the row direction RD, the second region side edge of the photoinduction region does not extend along the column direction CD but instead extends along an inclination direction. Accordingly, a difference between a space frequency of the photoinduction region of each of the photosensitive pixels P(1,1) to P(M,N) and a space frequency of a display pixel structure on the display panel 310 may be enlarged so that a contrast ratio of a Moire pattern generated in a fingerprint image generated by the fingerprint image sensor 310 may be reduced.

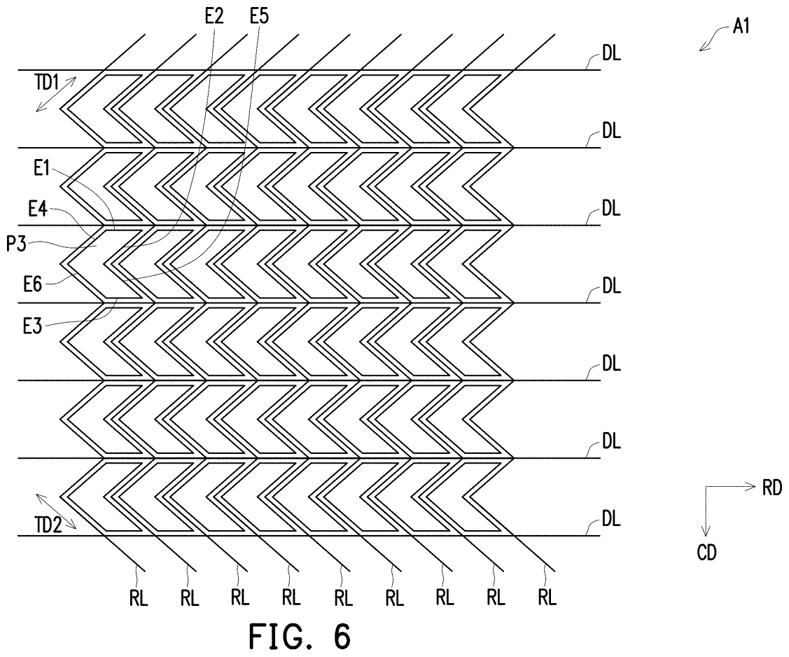

The examples of the photoinduction region are described in the embodiments below. FIG. 4A to FIG. 4C are schematic diagrams of photosensitive pixels according to an embodiment of the invention. Referring to FIG. 4A first, a first type photosensitive pixel P1 between a scan line DL and a data reading line RL includes a photoinduction region Z2. A shape of the photoinduction region Z2 is substantially a parallelogram. In other embodiments, the photoinduction region Z2 may be a parallelogram with a cut-off corner, which may be disposed according to actual requirements. The photoinduction region Z2 has a first region side edge E1, a second region side edge E2, a third region side edge E3, and a fourth region side edge E4. The first region side edge E1 is parallel to the third region side edge E3, and the second region side edge E2 is parallel to the fourth region side edge E4. The first region side edge E1 may extend along the row direction RD, and the second region side edge E2 may extend along a first inclination direction TD1. There is an acute angle θp between the first region side edge E1 and the second region side edge E2. Correspondingly, there is the same acute angle θp between the fourth region side edge E4 and the row direction RD.

Referring to FIG. 4B, a second type photosensitive pixel P2 between the scan line DL and the data reading line RL includes a photoinduction region Z3. A shape of the photoinduction region Z3 is substantially a parallelogram. In other embodiments, the photoinduction region Z3 may be a parallelogram with a cut-off corner, which may be disposed according to actual requirements. In FIG. 4B, the first region side edge E1 may extend along the row direction RD, and the second region side edge E2 may extend along a second inclination direction TD2. There is the acute angle θp between the first region side edge E1 and the second region side edge E2. Correspondingly, there is the acute angle θp between the fourth region side edge E4 and the row direction. Comparing FIG. 4A and FIG. 4B, the photoinduction region Z3 of the second type photosensitive pixel P2 and the photoinduction region Z2 of the first type photosensitive pixel P1 are substantially parallelograms, but the inclination directions of the two parallelograms are different.

Referring to FIG. 4C, a third type photosensitive pixel P3 between the scan line DL and the data reading line RL includes a photoinduction region Z4. The photoinduction region Z4 is presented as a hexagon in a shape of an arrow. In other embodiments, the photoinduction region Z4 may be a hexagon with a cut-off corner, which may be disposed according to actual requirements. The photoinduction region Z4 has the first region side edge E1, the second region side edge E2, the third region side edge E3, the fourth region side edge E4, a fifth region side edge E5, and a sixth region side edge E6. The first region side edge E1 is parallel to the third region side edge E3, the second region side edge E2 is parallel to the fourth region side edge E4, and the fifth region side edge E5 is parallel to the sixth region side edge E6. In an example of FIG. 4C, the first region side edge E1 extends along the row direction RD, the second region side edge E2 extends along the first inclination direction TD1, and the fifth region side edge E5 extends along the second inclination direction TD2. There is the acute angle θp between the first region side edge E1 and the second region side edge E2. In addition, there is the same acute angle θp between the third region side edge E3 and the fifth region side edge E5. According to the above, a smaller included angle between the second region side edge E2 and the fifth region side edge E5 is equal to twice the acute angle θp.

Note that, in the examples of FIG. 4A to FIG. 4C, considering that a photosensitive area is increased to enhance photosensitivity, the transistor, the capacitor, and some metal circuit layers required for the photosensitive pixel may be constructed at a bottom layer of the photosensitive pixel. Hence, a size and a top-view shape of the photosensitive pixel may be similar to a size and a shape of the photoinduction region. However, in other embodiments, some electronic components may be disposed next to the photoinduction region, and the invention is not limited thereto.

The examples of a layout of the photosensitive pixels are described in the embodiments below.

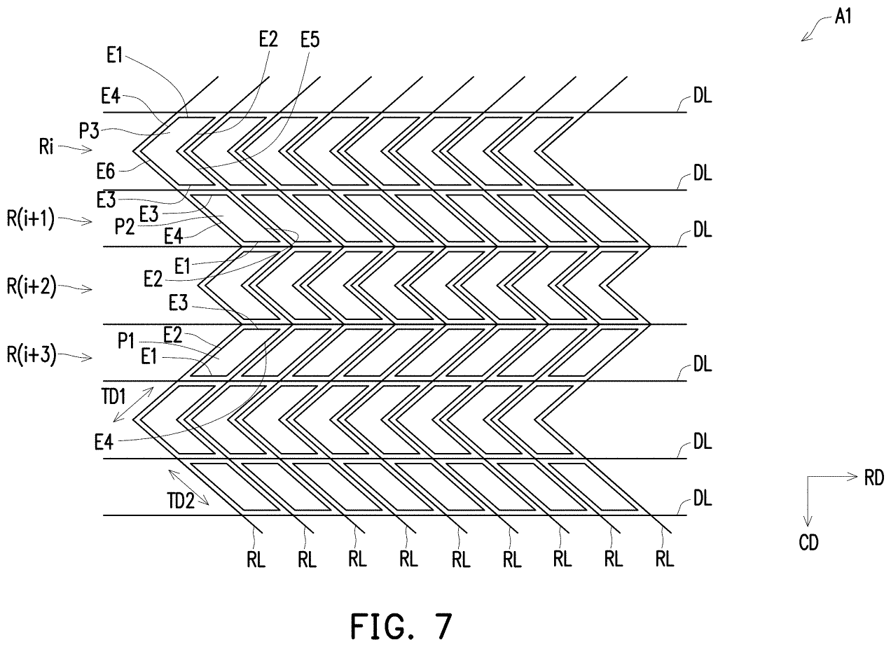

FIG. 5 is a schematic diagram of a layout of a fingerprint image sensor according to an embodiment of the invention. Referring to FIG. 5, the fingerprint image sensor 320 may include the multiple scan lines DL, the multiple data reading lines RL, and the photosensitive array A1. The photosensitive array A1 includes the multiple photosensitive pixels arranged in multiple rows and multiple columns. The shape of the photosensitive pixels is implemented as the parallelogram. In the layout example, the photosensitive array A1 may be formed by the first type photosensitive pixels P1 of FIG. 4A and the second type photosensitive pixels P2 of FIG. 4B that are alternately arranged.

Specifically, the photosensitive array A1 has an ith row Ri and an (i+1)th row R(i+1), and i is a positive integer less than M. The photosensitive pixels of the photosensitive array A1 include the multiple first type photosensitive pixels P1 disposed on the ith row Ri and the multiple second type photosensitive pixels P2 disposed on the (i+1)th row R(i+1). The first region side edge E1 of the first type photosensitive pixels P1 and the first region side edge E1 of the second type photosensitive pixels P2 extend along the row direction RD. The second region side edge E2 of the first type photosensitive pixels P1 extends along the first inclination direction TD1, and the second region side edge E2 of the second type photosensitive pixels P2 extends along the second inclination direction TD2. The first inclination direction TD1 is different from the second inclination direction TD2. In other words, the multiple first type photosensitive pixels P1 and the multiple second type photosensitive pixels P2 are alternately arranged to form a line of photosensitive pixels located between the two data reading lines RL in the photosensitive array A1. The photoinduction regions (i.e. pixel shapes) of the first type photosensitive pixels P1 and the second type photosensitive pixels P2 are respectively the two parallelograms with different inclination directions.

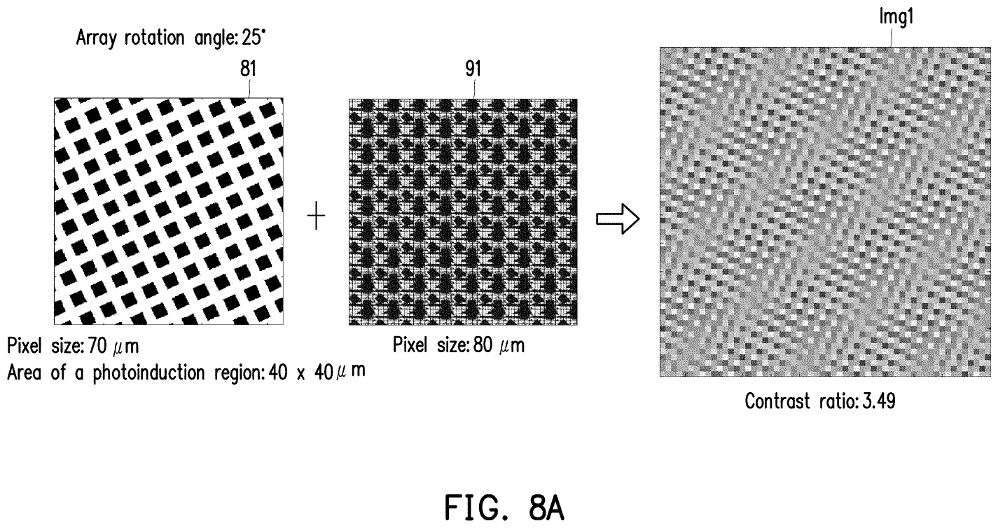

FIG. 6 is a schematic diagram of a layout of a fingerprint image sensor according to an embodiment of the invention. Referring to FIG. 6, the fingerprint image sensor 320 may include the multiple scan lines DL, the multiple data reading lines RL, and the photosensitive array A1. The photosensitive array A1 includes the multiple photosensitive pixels arranged in multiple rows and multiple columns. The shape of the photosensitive pixels is implemented as the hexagon in the shape of the arrow. In the layout example, the photosensitive array A1 may be formed by the third type photosensitive pixels P3 of FIG. 4C that are repetitively arranged. In other words, each of the photosensitive pixels in the photosensitive array A1 is the third type photosensitive pixel that is in the shape of the hexagon.

Specifically, in the example of FIG. 6, the first region side edge E1 of each of the photosensitive pixels (i.e. the third type photosensitive pixels P3) extends along the row direction RD, and the second region side edge E2 of each of the photosensitive pixels extends along the first inclination direction TD1. The fifth region side edge E5 of each of the photosensitive pixels extends along the second inclination direction TD2. The first region side edge E1 is parallel to the third region side edge E3. The second region side edge E2 is parallel to the fourth region side edge E4. The fifth region side edge E5 is parallel to the sixth region side edge E6. The first inclination direction TD1 is different from the second inclination direction TD2. In the example, a length of the second region side edge E2 and a length of the fifth region side edge E5 may be the same. In other words, the multiple third type photosensitive pixels P3 are repetitively arranged to form a line of photosensitive pixels located between the two data reading lines RL in the photosensitive array A1. The photoinduction regions (i.e. the pixel shapes) of the third type photosensitive pixels P3 are the hexagon in the shape of the arrow.

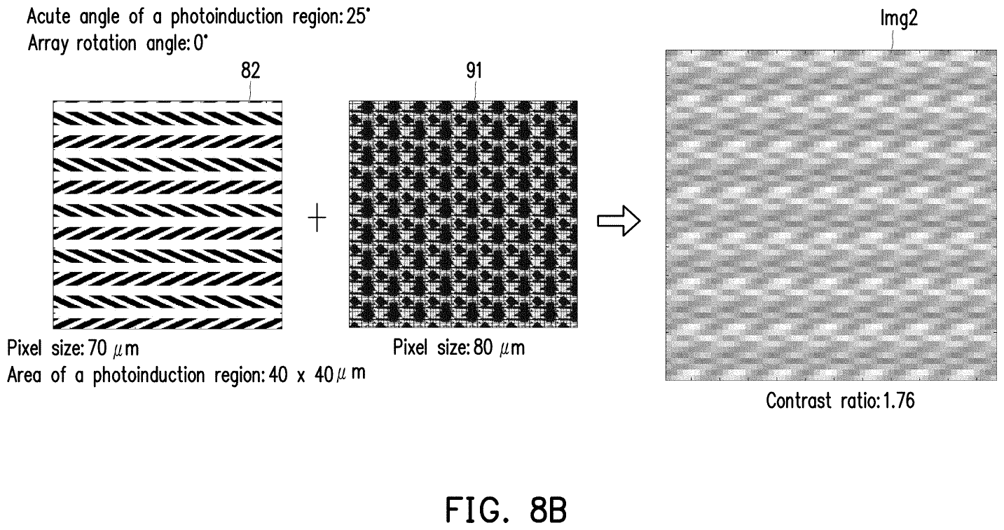

FIG. 7 is a schematic diagram of a layout of a fingerprint image sensor according to an embodiment of the invention. Referring to FIG. 7, the fingerprint image sensor 320 may include the multiple scan lines DL, the multiple data reading lines RL, and the photosensitive array A1. The photosensitive array A1 includes the multiple photosensitive pixels arranged in multiple rows and multiple columns. The shapes of the photosensitive pixels may include the parallelogram and the hexagon in the shape of the arrow. In the layout example, the photosensitive array A1 may be formed by the first type photosensitive pixels P1 of FIG. 4A, the second type photosensitive pixels P2 of FIG. 4B, and the third type photosensitive pixels P3 of FIG. 4C that are alternately arranged. The photosensitive pixels in the photosensitive array A1 may include the multiple first type photosensitive pixels P1 and the multiple second type photosensitive pixels P2 having the photoinduction regions in the shape of the parallelograms and the multiple third type photosensitive pixels P3 having the photoinduction regions in the shape of the hexagon.

Specifically, the photosensitive array A1 has the ith row Ri, the (i+1)th row R(i+1), an (i+2)th row R(i+2), and an (i+3)th row R(i+3), and i is the positive integer less than or equal to M−3. The third type photosensitive pixels P3 are disposed on the ith row Ri and the (i+2)th row R(i+2), the second type photosensitive pixels P2 are disposed on the (i+1)th row R(i+1), and the first type photosensitive pixels P1 are disposed on the (i+3)th row R(i+3).

In the example of FIG. 7, the first region side edge E1 of the first type photosensitive pixels P1 and the first region side edge E1 of the second type photosensitive pixels P2 extend along the row direction RD. The second region side edge E2 of the first type photosensitive pixels P1 extends along the first inclination direction TD1, and the second region side edge E2 of the second type photosensitive pixels P2 extends along the second inclination direction TD2. In addition, the first region side edge E1 of the third type photosensitive pixels P3 is parallel to the third region side edge E3 of the third type photosensitive pixels P3. The second region side edge E2 of the third type photosensitive pixels P3 is parallel to the fourth region side edge E4 of the third type photosensitive pixels P3, and the fifth region side edge E5 of the third type photosensitive pixels P3 is parallel to the sixth region side edge E6 of the third type photosensitive pixels P3. The first region side edge E1 of the third type photosensitive pixels P3 extends along the row direction RD. The second region side edge E2 of the third type photosensitive pixels P3 extends along the first inclination direction TD1, and the fifth region side edge E5 of the third type photosensitive pixels P3 extends along the second inclination direction TD2. The first inclination direction TD1 is different from the second inclination direction TD2.

In other words, the multiple first type photosensitive pixels P1, the multiple second type photosensitive pixels P2, and the multiple third type photosensitive pixels P3 are alternately arranged to form a line of photosensitive pixels located between the two data reading lines RL in the photosensitive array A1. In addition, the photoinduction regions (i.e. pixel shapes) of the first type photosensitive pixels P1 and the second type photosensitive pixels P2 are respectively the two types of parallelograms with different inclination directions, and the photoinduction regions (i.e. the pixel shapes) of the third type photosensitive pixels P3 are the hexagon in the shape of the arrow.

In the embodiments of FIG. 5 to FIG. 7, the shape of the photoinduction region of each of the photosensitive pixels is respectively the parallelogram with the acute angle or the hexagon with the acute angle. Accordingly, a correlation between the space frequency of the photoinduction regions and the space frequency of the display pixel structure on the display panel 310 may be changed in response to the acute angle that may be flexibly disposed, thereby reducing a negative effect caused by the Moire pattern.

In addition, as shown in FIG. 5 to FIG. 7, the multiple scan lines DL of the fingerprint image sensor 320 are disposed on the substrate B1 and extend along the row direction RD in a shape of a straight line. The multiple data reading lines R1 are disposed on the substrate B1 and extend alternately along the first inclination direction TD1 and the second inclination direction TD2 in a zigzag shape. Hence, relative positions of an input end and an output end of the scan lines DL and an input end and an output end of the data reading lines RL are similar to those of a conventional image sensor without greatly changing other wire layouts in response to the pixel shape.

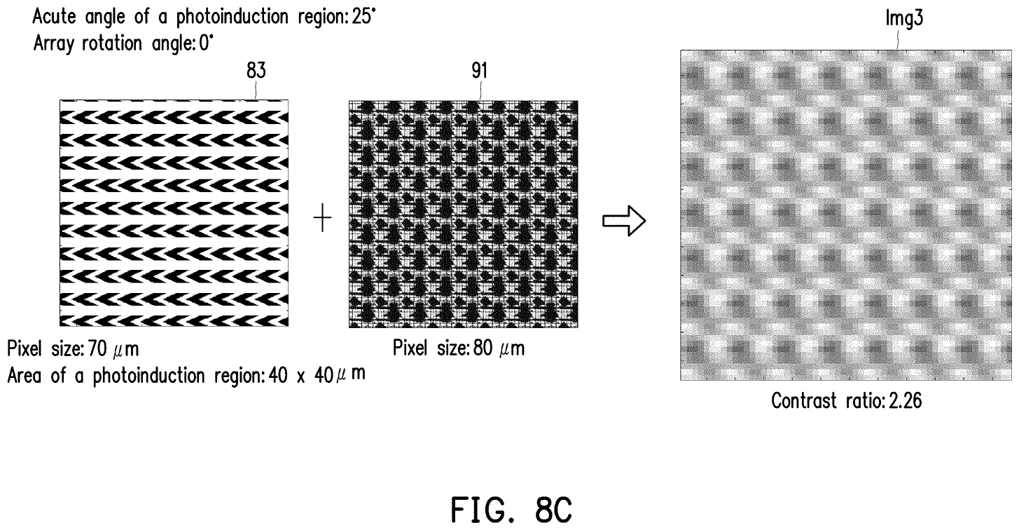

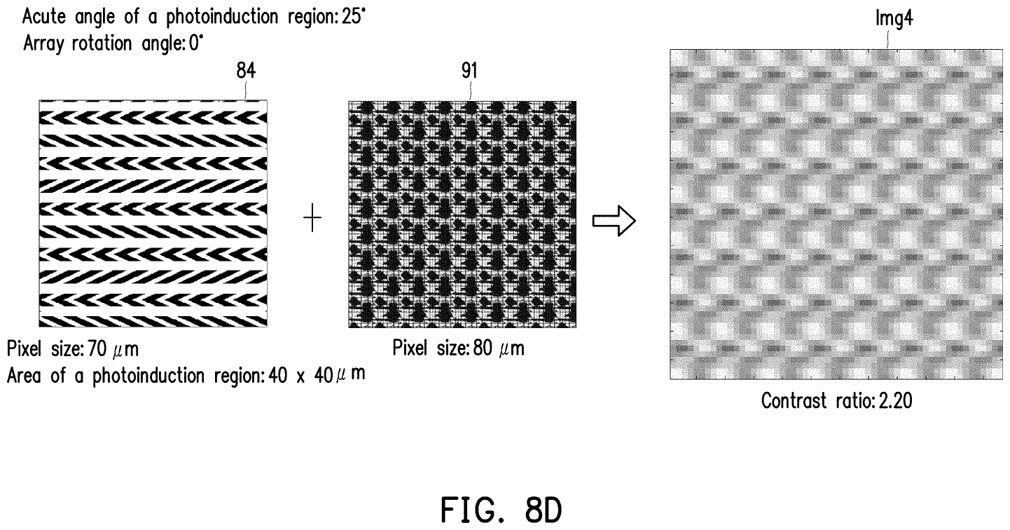

FIG. 8A is a simulation diagram of a Moire pattern of a conventional rotated image sensor. Referring to FIG. 8A, it is assumed that a pixel size of a photosensitive pixel of a photosensitive array 81 is 70 μm, an area of a photoinduction region is 40 μm*40 μm, and a pixel size of a display pixel of a display panel 91 is 80 μm. The photosensitive array 81 of a conventional fingerprint image sensor is rotated 25 degrees. In this case, a contrast ratio of interference stripes on a sensing image Img1 generated by the photosensitive array 81 is simulated as 3.49 (i.e. a ratio of a brightest photosensitivity value to a dimmest photosensitivity value).

FIG. 8B to FIG. 8D are simulation diagrams of a Moire pattern of adjustment of a photoinduction region according to an embodiment of the invention. Note that in FIG. 8B to FIG. 8D, the photoinduction region has, for example, an acute angle of 25 degrees for description; however, the invention is not limited thereto.

Referring to FIG. 8B, it is assumed that a pixel size of a photosensitive pixel of a photosensitive array 82 is 70 μm, an area of a photoinduction region is 40 μm*40 μm, and the pixel size of the display pixel of the display panel 91 is 80 μm. A layout of FIG. 5 is adopted as a layout of a photosensitive array 82. In this case, a contrast ratio of interference stripes on a sensing image Img2 generated by the photosensitive array 82 is simulated as 1.76.

Referring to FIG. 8C, it is assumed that a pixel size of a photosensitive pixel of a photosensitive array 83 is 70 μm, an area of a photoinduction region is 40 μm*40 μm, and the pixel size of the display pixel of the display panel 91 is 80 μm. A layout of FIG. 6 is adopted as a layout of a photosensitive array 83. In this case, a contrast ratio of interference stripes on a sensing image Img3 generated by the photosensitive array 83 is simulated as 2.26.

Referring to FIG. 8D, it is assumed that a pixel size of a photosensitive pixel of a photosensitive array 84 is 70 μm, an area of a photoinduction region is 40 μm*40 μm, and the pixel size of the display pixel of the display panel 91 is 80 μm. A layout of FIG. 7 is adopted as a layout of a photosensitive array 84. In this case, a contrast ratio of interference stripes on a sensing image Img4 generated by the photosensitive array 84 is simulated as 2.20. Referring to the simulation diagrams of FIG. 8A to FIG. 8D, by providing the photoinduction region that is not a rectangle and with the acute angle, the negative effect caused by the Moire pattern on the fingerprint image may be effectively reduced.

In summary of the above, in the embodiments of the invention, there is the acute angle between the first region side edge and the second region side edge of the photoinduction region of the photosensitive pixel so that the photoinduction regions of the photosensitive pixels may be the parallelogram or the hexagon in the shape of the arrow. As a result, in a case where the fingerprint image sensor is configured below the display panel, the correlation between the space frequency of the pixel structure on the display panel and the space frequency of the photosensitive pixel may be changed to greatly reduce the negative effect caused by the Moire pattern on the fingerprint image. In addition, compared with a conventional solution of the conventional rotated image sensor, the fingerprint image sensor of the embodiments of the invention may be applied to a large area (e.g. a full screen) of under-screen fingerprint recognition. The application is broadened without being affected by an assembly tolerance.

Finally, it should be noted that the above embodiments are only used to illustrate the technical solutions of the invention, but not to limit the invention. Although the invention has been described in detail with reference to the embodiments, persons of ordinary skill in the art should understand that modifications may be made to the technical solutions of the embodiments of the invention, or that some or all of the technical features may be equivalently replaced. However, the modifications or replacements do not cause the essence of the corresponding technical solutions to deviate from the scope of the technical solutions of the embodiments of the invention.

What is claimed is:

1. A fingerprint image sensor adapted to be configured below a display panel, wherein the fingerprint image sensor comprises:
a substrate; and
a plurality of photosensitive pixels, wherein the photosensitive pixels are arranged to be a photosensitive array having M rows and N columns on the substrate, the photosensitive pixels on each row of the photosensitive array are arranged along a row direction, and the photosensitive pixels on each column of the photosensitive array are arranged along a column direction, wherein M and N are positive integers,
wherein each of the photosensitive pixels comprises a photoinduction region, the photoinduction region has a first region side edge and a second region side edge, there is an acute angle between the first region side edge and the second region side edge, and the acute angle is greater than 0 and less than 90 degrees.

2. The fingerprint image sensor according to claim 1, wherein a shape of the photoinduction region comprises a parallelogram, the photoinduction region further comprises a third region side edge and a fourth region side edge, the first region side edge is parallel to the third region side edge, and the second region side edge is parallel to the fourth region side edge.

3. The fingerprint image sensor according to claim 2, wherein the photosensitive array has an ith row and an (i+1)th row adjacent to each other, and the photosensitive pixels comprise a plurality of first type photosensitive pixels disposed on the ith row and a plurality of second type photosensitive pixels disposed on the (i+1)th row, wherein i is a positive integer less than M,
wherein the first region side edge of the first type photosensitive pixels and the first region side edge of the second type photosensitive pixels extend along the row direction, the second region side edge of the first type photosensitive pixels extends along a first inclination direction, and the second region side edge of the second type photosensitive pixels extends along a second inclination direction.

4. The fingerprint image sensor according to claim 1, wherein a shape of the photoinduction region comprises a hexagon in a shape of an arrow, the photoinduction region further comprises a third region side edge, a fourth region side edge, a fifth region side edge, and a sixth region side edge, the first region side edge is parallel to the third region side edge, the second region side edge is parallel to the fourth region side edge, and the fifth region side edge is parallel to the sixth region side edge.

5. The fingerprint image sensor according to claim 4, wherein the first region side edge of each of the photosensitive pixels extends along the row direction, the second region side edge of each of the photosensitive pixels extends along a first inclination direction, the fifth region side edge of each of the photosensitive pixels extends along a second inclination direction, and there is the same acute angle between the third region side edge and the fifth region side edge.

6. The fingerprint image sensor according to claim 1, wherein a shape of the photoinduction region comprises a parallelogram and a hexagon in a shape of an arrow, the photosensitive pixels comprise a plurality of first type photosensitive pixels and a plurality of second type photosensitive pixels having the photoinduction region in the shape of the parallelogram and a plurality of third type photosensitive pixels having the photoinduction region in the shape of the hexagon.

7. The fingerprint image sensor according to claim 6, wherein the first region side edge of the first type photosensitive pixels and the first region side edge of the second type photosensitive pixels extend along the row direction, the second region side edge of the first type photosensitive pixels extends along a first inclination direction, and the second region side edge of the second type photosensitive pixels extends along a second inclination direction.

8. The fingerprint image sensor according to claim 7, wherein the photosensitive array has an ith row, an (i+1)th row, an (i+2)th row, and an (i+3)th row sequentially adjacent to each other, the third type photosensitive pixels are disposed on the ith row and the (i+2)th row, the second type photosensitive pixels are disposed on the (i+1)th row, and the first type photosensitive pixels are disposed on the (i+3)th row, wherein i is a positive integer less than or equal to M−3,
wherein the first region side edge of the third type photosensitive pixels is parallel to the third region side edge of the third type photosensitive pixels, the second region side edge of the third type photosensitive pixels is parallel to the fourth region side edge of the third type photosensitive pixels, and the fifth region side edge of the third type photosensitive pixels is parallel to the sixth region side edge of the third type photosensitive pixels,
the first region side edge of the third type photosensitive pixels extends along the row direction, the second region side edge of the third type photosensitive pixels extends along the first inclination direction, and the fifth region side edge of the third type photosensitive pixels extends along the second inclination direction.

9. The fingerprint image sensor according to claim 1, further comprising:
a plurality of scan lines disposed on the substrate and extending along the row direction in a shape of a straight line; and
a plurality of data reading lines disposed on the substrate and extending alternately along the first inclination direction and the second inclination direction in a zigzag shape.

10. The fingerprint image sensor according to claim 1, wherein each of the photosensitive pixels comprises a photo-diode having the photoinduction region.

11. An electronic device, comprising:
a display panel; and
a fingerprint image sensor configured below the display panel and comprising:
a substrate; and
a plurality of photosensitive pixels, wherein the photosensitive pixels are arranged to be a photosensitive array having a plurality of rows and a plurality of columns on the substrate, the photosensitive pixels on each row of the photosensitive array are arranged along a row direction, and the photosensitive pixels on each column of the photosensitive array are arranged along a column direction,
wherein each of the photosensitive pixels comprises a photoinduction region, the photoinduction region has a first region side edge and a second region side edge, there is an acute angle between the first region side edge and the second region side edge, and the acute angle is greater than 0 and less than 90 degrees.
